(19) United States
(12) Patent Application Publication
(10) Pub. No.: US 2007/0205114 A1
(43) Pub. Date: Sep. 6, 2007

(54) Method of detecting biosensor filling

(76) Inventor: Vijaywanth Pratap Mathur, San Diego, CA (US)

Correspondence Address: AZURE INSTITUTE;INTELLECTUAL PROPERTY DEPT., 4108 SORRENTO VALLEY BOULEVARD, SAN DIEGO, CA, 92124, US

(21) Appl. No.: 11/366,647

(22) Filed: Mar. 1, 2006

(51) Int. Cl. G01F 1/64

(52) U.S. Cl. 205/792

(57) ABSTRACT

The present invention is directed to methods of detecting filling of the capillary channel of a biosensor test strip. In one embodiment the biosensor test strip has three electrodes: a first reference electrode, a working electrode and a second reference electrode, which are arranged sequentially within the capillary channel of a biosensor test strip and perpendicular to the axis thereof. A test sample containing an analyte of interest is applied to the test strip. A first voltage (V1) is applied between the first reference electrode and the working electrode, and a first current (i1) is detected. If i1 is detected, a second voltage (V2) is applied between the working electrode and the second reference electrode. A second current (i2) is detected, indicating that an applied sample has covered the first and second reference electrodes and the working electrodes. The measuring device then conducts the assay for the presence or amount of the analyte of interest in the test sample.

### FIELD OF THE INVENTION

The present invention relates to devices and methods for detecting application of a sample to a biosensor.

### BACKGROUND OF THE INVENTION

The following Background of the Invention is intended to aid the reader in understanding the invention and is not admitted to be prior art.

A variety of medical conditions require that a patient monitor the concentration of analytes in body fluids. For example, persons affected by diabetes must often monitor their blood sugar levels. Persons affected by other medical conditions often must monitor blood or other fluid levels of other analytes. When blood in the body fluid to be monitored, a typical procedure involves piercing the skin and obtaining a droplet of blood, and placing it on a biosensor that is used in conjuction with a device that measures the blood concentration of glucose or another body fluid analyte.

Several examples of biosensors are available. For example, U.S. Pat. Nos. 5,120,420 and 5,320,732 to Nankai, U.S. Pat. No. 5,141,868 to Shanks and U.S. patent application 2003/0196894 to Cai disclose disposable glucose biosensors constructed of two plastic layers laminated to spacers thereby holding the parts together. The parts form a vented capillary channel that draws an applied sample into the interior and onto a test area. Venting is required for the capillary channel to function properly. When the sample flows into the channel by capillary flow, the sample comes into contact with an enzyme layer and electrodes, which detect and optionally measure an analyte in the sample.

To reduce the pain associated with sample collection, lancing devices have been designed to make as shallow a cut as possible. As a result, much smaller blood samples are produced. Concurrently, test strips have been redesigned to require much smaller samples. To utilize very small samples, on the order of 1 to 10 μl, test strips have very small capillary channels. Unfortunately, patients can have difficulty filling these small capillary channels. If the sample filling the capillary channel does not cover the electrodes or is broken by a bubble, the meter will not correctly detect the analyte. Therefore there is a persistent and unmet need for a method of detecting filling of the capillary channel of a biosensor test strip.

### SUMMARY OF THE INVENTION

The present invention provides devices for detecting analytes in a fluid sample, and methods for detecting the filling of a biosensor capillary with sample fluid. In one embodiment the devices of the invention are biosensors configured for detection of glucose in a blood sample, and the biosensors are used with an electronic meter with which they can be connected for measurement of the glucose level in the blood. The biosensors can have a capillary channel into which fluid sample is drawn and held, and an electrode system having electrodes situated within the capillary channel. Reagents can be present within the capillary channel that produce oxidation-reduction products in response to the presence of analyte (e.g., glucose) in the sample. In one embodiment the capillary channel has three electrodes: a working electrode, a first reference electrode, and a second reference electrode, with the first reference electrode being situated closest to the capillary entrance. In one embodiment the devices are used with methods for detecting the filling of the capillary channel before a measurement is taken. The methods involve detection of the presence of sample by applying a voltage (V1) to the working electrode relative to the first reference electrode and detecting a first threshold current (i1), indicating the presence of sample. If the threshold current is detected, then a second voltage (V2) is applied to the working electrode relative to the second reference electrode, and a second threshold current (i2) detected. If the second threshold current is detected within a set time period, a measurement for the analyte is then taken. The measurement can be taken by continuing the voltage on the working electrode (W) relative to second reference electrode (R2) until a reading is obtained.

Therefore, in a first aspect the present invention provides methods of detecting application of liquid sample to a biosensor. The methods involve contacting the liquid sample with a biosensor having an opening to a capillary channel containing a first reference electrode, a working electrode, and a second reference electrode, connecting the biosensor to a device for applying voltage to the biosensor; and applying a first voltage (V1) to the working electrode relative to the first reference electrode and detecting a first current (i1). The method also involves applying a second voltage (V2) to the working electrode relative to the second reference electrode and detecting a second current (i2). The presence of i2 indicates sample has been applied to the biosensor. Application of the liquid sample to the biosensor is thereby detected.

In one embodiment, the first reference electrode, working electrode, and second reference electrode lie perpendicular to the axis of the capillary channel. In a further embodiment, the first reference electrode, working electrode, and second reference electrode are linearly present on sequential axes and on the same base layer portion. The electrodes can be present on sequential axes lying perpendicular to the axis of the capillary channel, and the sequentially axes can have a linear form. In one embodiment the first reference electrode is closest to the opening of the capillary channel and the second reference electrode is farthest from the opening of the capillary channel. The working electrode can be present in between the first and second reference electrodes. The biosensor can also have a vent through which air can escape from the capillary channel to the exterior of the biosensor.

In one embodiment the biosensor has at least three leads. The leads independently connect the first reference electrode, working electrode, and second reference electrode to at least three independent contacts of a metering device. The electrodes are formed of an electrically conducting ink. The electrically conducting ink can be made of silver, platinum, palladium, gold, carbon, and any combination thereof. The biosensor also has, within the capillary channel, reagents for detecting the analyte. In one embodiment the reagents include an enzyme and a mediator. In certain embodiments, the enzyme is deposited only on the working electrode and the mediator is deposited on all three electrodes. In other embodiments the enzyme and mediator are deposited on all three electrodes.

In another embodiment of the present method, if i1 is detected, then V1 is discontinued, and if i1 is not detected, then an error is reported. Furthermore, if i1 is detected but i2 is not detected, then an error is reported.

In yet another embodiment, the biosensor contains reagents for detecting an analyte, which can be glucose, cholesterol or alcohol. The sample can be a biological sample. In some embodiments the sample is blood or a blood product. In another embodiment, the biosensor can be at least partially made of a polyester substrate. In one embodiment the capillary of the biosensor is formed from a spacer and a hydrophilic top cover applied on the substrate.

The summary of the invention described above is not limiting and other features and advantages of the invention will be apparent from the following detailed description, as well as from the claims.

### BRIEF DESCRIPTION OF THE DRAWINGS

FIG. 1 provides an exploded view of one embodiment of an electrochemical biosensor test strip 100 to be used with the present method.

FIG. 2 is a top view of the support layer, 150 of the device of FIG. 1, illustrating one embodiment of the electrode system.

FIG. 3 is a flow chart illustrating a method of detecting the filling of an electrochemical biosensor capillary channel, in accordance with one embodiment of the present invention.

### DETAILED DESCRIPTION

In the following detailed description, reference is made to the accompanying drawings that form a part hereof, and in which is shown by way of illustration specific embodiments in which the invention may be practiced. It is understood that with reference to the present disclosure other embodiments may be utilized and structural changes may be made without departing from the scope of the present invention.

One aspect of the present invention is a method of detecting application of biological fluid sample to a biosensor. A “biosensor” is a device configured to receive and hold a sample, and contains components necessary for detection of the presence or amount of an analyte in the sample in conjunction with a reading device. In one embodiment the biosensor can detect the presence or amount of the analyte via an electrochemical oxidation/reduction reaction. The products of the reaction are detected by an electrical signal that correlates with an amount or concentration of analyte. In various embodiments the sample can be a biological fluid, such as blood, plasma, or serum. A “biological fluid” is any body fluid in which the analyte can be detected or measured, for example, blood, interstitial fluid, dermal fluid, sweat, and tears. The term “blood” in the context of the invention includes whole blood and its cell-free components, such as, plasma and serum.

Biosensor Test Strip

The present invention provides methods of detecting the filling of a capillary channel of an electrochemical biosensor. Any biosensor having the characteristics described herein can be used in the invention. With reference to the present disclosure persons of ordinary skill in the art will realize other configurations of biosensors that can also be used in the methods. The biosensors of the invention can also be used with any device configured with software or firmware that applies the steps described herein. In one embodiment the biosensors are useful for measuring glucose levels in blood, and can be used with a glucose meter configured to receive the biosensors and apply the methods of the invention.

Base Layer

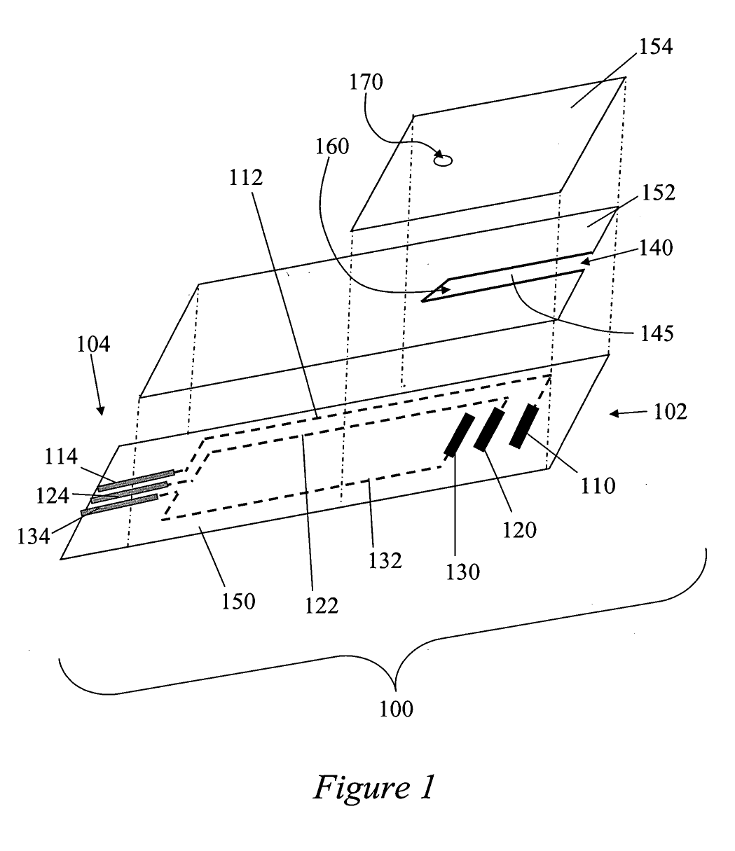

Referring to FIG. 1, there is illustrated an example of one embodiment of an electrochemical biosensor test strip 100. In this embodiment the biosensor test strip 100 has a proximal end 102 and a distal end 104. The test strip shown in FIG. 1 has a base layer 150, a spacer 152 and a cover 154. In other embodiments additional components of the test strip can be included. In one embodiment the working electrode and first and second reference electrodes are present on the same base layer portion, i.e., the electrodes are contained entirely on the base layer portion of the device and are not distributed on the base layer and additionally on another portion of the biosensor, e.g., a side wall.

The three components can be made of any rigid or semi-rigid material. In one embodiment the base layer 150 is made of a dielectric material. Examples of materials that can be used for the base layer include, but are not limited to, carbon, polystyrene, polycarbonate, polyvinyl chloride, polyester, glass, and silica. In one embodiment the base layer is constructed of polyethylene terephthalate (PET). For example, a strip of PET 5 mil thick provides an appropriate support, as does a 14 mil white film PET. But many different thicknesses and materials will also function in the invention. The base layer provides a support for receiving and holding the electrodes and electrode leads. The term “capillary” or “capillary channel” refers to a channel of internal diameter sufficiently small to take in and hold liquid by capillary action. Capillary action refers to the forces of adhesion, cohesion, and surface tension that act between a liquid and a surface with which it is in contact. It refers to the forces that result from greater adhesion of a liquid to a solid surface than internal cohesion of the liquid itself. These forces cause the liquid to be pulled into and retained within the capillary channel. The capillary channel can be of any shape, e.g., a tubular shape with a single curved interior surface, or having multiple flat surfaces in a rectangular or cubicle interior.

Spacer

In some embodiments the device contains a spacer, which serves to lift the cover off of the surface of the base layer and provide volume that is the capillary channel. The spacer can be made of a dielectric material, such as a plastic. Examples of suitable dielectric materials for use as the spacer include, but are not limited to, dielectric inks, adhesives, adhesive tape or film, celluloid materials, glass, and dielectric foils. In other embodiments, the spacer can be a layer of dielectric ink screen printed on the base layer. In one embodiment the dielectric ink is approximately 100 to 175 μm thick. Suitable dielectric inks include, but are not limited to, hydrophobic UV curable white dielectric ink.

In one embodiment, the spacer is made of a plastic, such as PET, into which a groove 145 is made. The inner surface of the groove 145 will form the sides of the capillary channel at or near the proximal end of the test strip when the biosensor is fully assembled. In the embodiment depicted the cover 154 covers the groove 145 and forms the top of the capillary channel. In this embodiment the cover does not extend past the distal end 160 of the capillary channel much more than necessary to completely cover the groove and form the capillary channel.

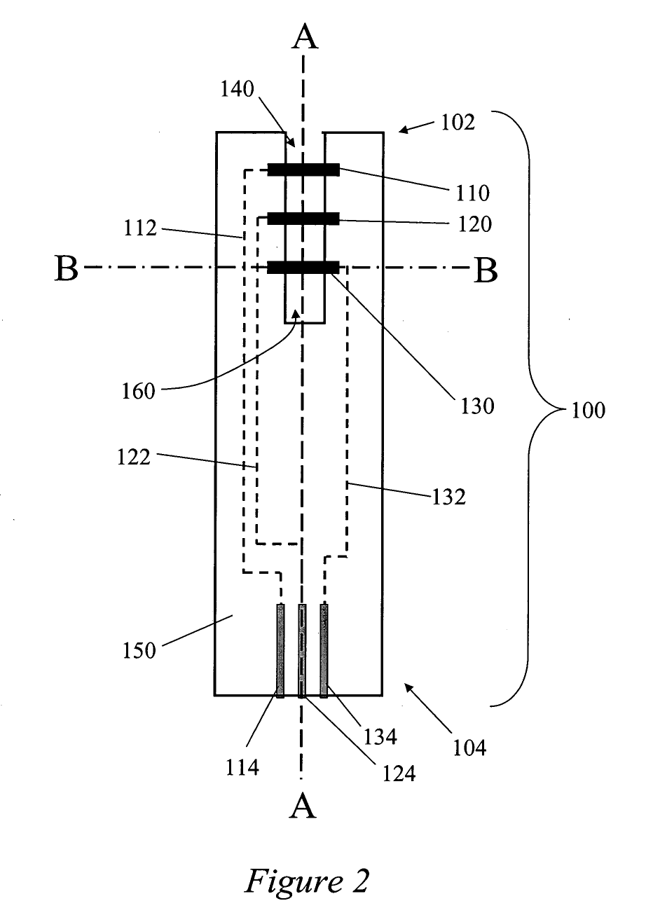

In the embodiment depicted in FIG. 1, the capillary channel extends from the proximal end 102 of the biosensor test strip, beginning at the sample opening 140 and extending as a capillary channel towards the distal end 104 of the device. Thus, in this embodiment the capillary channel is situated along the axis of the biosensor test strip. The axis of the biosensor test strip is determined by a straight line through the center of the test strip, running lengthwise (referring to FIG. 2 and line A). The capillary channel may have a variety of configurations or shapes. For example, in the embodiment depicted in FIG. 1, the capillary channel is situated parallel to the axis of the biosensor test strip and the sample opening 140 is located at the test strip proximal end 102. The axis of the capillary channel is determined by a straight line through the centermost portion of the channel and passing over a part of each electrode. Alternatively, the capillary channel axis may be perpendicular to the test strip axis, with the sample opening 140 situated on a side edge of the test strip. In some embodiments the capillary has a vent 170 near its distal end 160. The vent can be placed through the cover or base layer, or through the spacer at a side edge. A vent, if present, allows for the egress of air from the capillary as the capillary is filled with the sample. In one embodiment, the capillary has a volume of about 0.5 to 5 μL. In various embodiments the capillary channel has a volume of about 0.5 to 2 μL, or about 0.5 to 1.5 μL. In another embodiment, the capillary channel has a volume of about 1 to 1.5 μL. The “volume” of the capillary is the volume of liquid sample the capillary can hold.

Cover

In one embodiment the cover 154 of the device is made of a dielectric material. The materials selected can be any of the same as those selected for the base layer or spacer. In some embodiments, the cover can be a dielectric ink, which can be printed onto the device. In the embodiment depicted the cover is a film made of a hydrophilic material (e.g., polyester hydrophilic film from Adhesive Research, Erie, Pa., USA). But in other embodiments the cover can be made of other suitable materials, such as glass or a suitable plastic (e.g., PET). It can also be made of a hydrophobic material that has been treated to render its surface hydrophilic (e.g., poly(ethylene terephthalate), and thereby allow aqueous fluids to move along a surface of the cover within the capillary channel. In different embodiments the cover can extend up to the full length of the spacer, or can cover only the capillary channel. In one embodiment, the cover covers the proximal one-third of the biosensor test strip. In one embodiment the cover 154 is made of a hydrophilic material. In various embodiments the contact angle of water on the cover material is less than or equal to 20 degrees. But in other embodiments the contact angle is less than 14 degrees or less than 8 degrees. In various embodiments the cover has affixed thereto a double sided pressure sensitive adhesive to adhere the cover to the spacer, and thereby form the capillary channel. The contact angle is the angle at which a liquid interface meets the solid surface as measured by any method known to those of skill in the art.

In another embodiment, the cover covers the capillary channel from the sample opening 140 to almost its distal end, so that a small vent hole is left at the distal end of the capillary channel 160. The vent hole 170 allows gas present in the capillary channel to escape as sample enters through the sample opening 140. Alternatively, the vent hold can be present in the cover to allow gas present in the capillary channel to escape as sample enters the sample opening.

Electrodes/Leads/Contacts

The biosensor has an electrode system incorporated therein (FIGS. 1-2). In one embodiment the electrode system is formed entirely on the base layer. The electrode system has at least three electrodes 110, 120, 130 and corresponding leads 112, 122, 132 and contacts 114, 124 and 134. In one embodiment each electrode has an individual lead connected to it to an individual contact. Referencing FIGS. 1-2, in one embodiment the at least three electrodes include a working electrode (W1) 120, a first reference electrode (R1) 110, and a second reference electrode (R2) 130. In one embodiment, the contacts are the distal portions of the leads and are exposed to permit the biosensor to be inserted into and electrically connected to a measuring device. By “electrically connected” is meant that the biosensor test strip and measuring device are connected so that a voltage can be applied by the measuring device to the biosensor test strip, and an electrical current detected. When the biosensor test strip is inserted into a measuring device (e.g., a meter device), the contacts are electrically connected to corresponding contacts on the measuring device, so that the meter can apply electricity to the test strip and measure the current on the test strip. In a further embodiment, the contacts may include an additional layer of conductive ink, either covering or touching the distal ends of the leads. The contacts 114, 124, 134 are exposed at the distal end of the test strip for insertion into the measuring meter and for connection with the circuitry therein.

The electrode system is printed on the base layer using any convenient method. For example, the electrode system may be screen printed, in one or more layers of various conducting inks, onto the base. Dielectric inks may also be printed on the base, to define parts of the electrode system, such as to insulate one or more portions of the electrode system. Ag/AgCl, carbon (graphite), palladium, gold, platinum, iridium, indium tin oxide, and other suitable conducting materials can for the electrodes, leads, or contacts, or be constituents thereof. These materials (or combinations thereof) can also form constituents of the conducting inks, in embodiments where such are used. For example, one portion of the electrode can be one material and another portion of the same electrode can be another material. In one embodiment, the leads are screen printed on the base, for example with a silver or silver chloride conductive ink. After drying, the electrodes are printed at the proximal ends of the leads, using a carbon-based conductive ink. A dielectric ink may then be printed on portions of the leads and electrodes, to electrically insulate them.

Referring to FIG. 1, in this embodiment the working electrode and first and second reference electrodes are present on the base layer only. Thus, in this embodiment neither of the electrodes is present on another component of the biosensor, but are all present on the base layer. In one embodiment the base layer is a flat planar surface. In this embodiment the electrodes are present on the base layer situated sequentially and perpendicular to the axis of the capillary channel. Thus, with reference to FIG. 2 there is shown the axis of the biosensor test strip identified as A and passing along the base plate. The axis of the second reference electrode 130 is identified as axis B. The working electrode 120, first reference electrode 110, and second reference electrode 130 are present on the base plate perpendicular to the axis A. In this embodiment each electrode is present perpendicular to the axis of the capillary channel. The axis of the electrode is measured on the electrode as the longest straight line passing through the center of the electrode. In other embodiments other configurations of the components of the biosensor test strip are possible and may also be used in the invention. In different embodiments the electrodes can have other shapes. For example the electrodes may have a circular or oval shape in some embodiments.

In some embodiments the electrodes are present having a bar-shape, for example as depicted in FIG. 1. The electrodes can be present on sequential axes lying perpendicular to the axis of the capillary channel. In some embodiments the axes along which the electrodes are present are linear in form, and the electrode is present on the axis. Thus, the axes can have a linear shape and be present sequentially along the biosensor. In some embodiments no overlap exists between the axes, as they are linear and lie parallel to one another. The electrodes also can be present in sequence on sequential axes lying perpendicular to the axis of the capillary channel.

In one embodiment the electrodes are positioned sequentially within the capillary channel, with the first reference electrode (R1) 110 located closest to the sample opening, the second reference electrode 130 present farthest from the sample opening, and the working electrode 120 present in between the first and second reference electrodes. The term “reference electrode” refers to an electrode paired with a second electrode (to which voltage is applied, e.g., a working electrode) and through which passes an electrical current equal in magnitude and opposite in sign to the current passed through the second electrode. A “working electrode” is an electrode at which voltage is applied relative to a second (reference) electrode. At the working electrode reagents and/or analyte can be electro-oxidized or electro-reduced with or without the agency of a redox mediator. The current through the sample liquid can then be measured and correlated to an analyte concentration in the test sample. In one embodiment the first reference electrode is connected to contact 114 by lead 112, the working electrode. W1 is connected to contact 124 by lead 122, and the second reference electrode R2 is connected to contact 134 by lead 132. In various embodiment a voltage is applied to the working electrode relative to either of the first or second electrodes, or to both the first and second reference electrodes together.

Reagent System

A reagent system or reaction layer is placed on one or more electrodes for measurement of an analyte in the test sample by an oxidation-reduction reaction. The reagent system can be selected from a variety of reagent systems, depending upon the analyte of interest. Components of the reagent system may be applied in one or more layers to one or more of the electrodes in any combinations. In some embodiments the reagents contain an enzyme and a redox mediator. The selection of the enzyme and redox mediator is dependent upon the analyte to be detected.

Depending upon the analyte to be detected, a variety of enzymes can be contained in the reagent(s). Examples of suitable enzymes that can be used for measuring the concentration of various analytes include glucose oxidase, alcohol dehydrogenase, lactate dehydrogenase, 3-hydroxybutyrate dehydrogenase, glucose-6-phosphate dehydrogenase, glucose dehydrogenase, formaldehyde dehydrogenase, malate dehydrogenase, cholesterol oxidase, choline oxidase, choline esterases and 3-hydroxysteroid dehydrogenase. In some embodiments the reagent system also includes reagents to adjust characteristics of the applied sample and stabilizers or preservatives, such as buffers, antifoaming agents, surfactants, salts, fillers, binders, and carbohydrates.

A “redox mediator” is an electron transfer agent for carrying electrons between the analyte and the working electrode, either directly or via the enzyme. Suitable redox mediators include, but are not limited to, transition metal compounds or complexes (e.g., osmium, ruthenium, iron or cobalt or compounds containing one or more of these metals), heterocyclic nitrogen compounds containing a transition metal or metallocene derivatives (ferrocene). Redox mediators can include a nicotinamide cofactor (NADH or NADPH). Redox mediators may be leachable or non-leachable, such as non-leachable redox polymers. If the redox mediator is non-leachable, then it must be applied to all of the electrodes. In one embodiment of the present invention, the redox mediator if potassium hexacyanoferrate (III) (K₃Fe(CN₆), available from Sigma-Aldrich, St. Louis, Mo., USA).

The components of the reagent system can be applied to the electrodes in one or more layers. For example, a solution containing the redox mediator can be applied and dried onto all three electrodes or only on two or one of the electrodes. The reagents can also be applied to any surface within the capillary channel. The redox mediator solution can be applied by various methods, such as pipetting, screen printing, ink jet printing, or printing with a dot-matrix printer. A solution containing the enzyme can be applied to one or more of the electrodes as a first or second layer. In another example, a solution containing both the redox mediator and the enzyme is applied to one or more of the electrodes. In different embodiments the mediator solution is applied to all electrodes and dried, followed by application of an enzyme solution to the working electrode only, or the mediator solution can be applied to all electrodes and dried, followed by application of the enzyme solution to all of the electrodes. The order of application of reagents is not important and can be varied to any order. Thus, redox mediator reagent can be applied first, followed by enzyme, or vice versa, or the reagents can be applied together as a single solution. Binders can also be applied either individually or as part of the enzyme or redox mediator. Various other processes of application will be apparent to the person of ordinary skill with reference to the present disclosure.

In one embodiment the analyte of interest is glucose present in blood (e.g., whole blood). In this embodiment, the reagent system can include glucose oxidase. In some embodiments the reagents can also include a binder, such as hydroxyethylcellulose (HEC). The NATROSOL® (Hercules, Inc., Wilmington, Del.) HEC M polymer can also be used to bind the components of the reagent layer. This binder is hydrophilic and can also be used to mix with the incoming blood sample so that an electrochemical cell is established in a period of seconds. Other materials can also be used as the binder, for example, hydroxymethylcellulose and hydroxypropylcellulose. A stablilizer can also be included in the reagent formulation. In various embodiments different stabilizers can be used. For example, trehalose or polyethylene glycol (PEG) can be included as stabilizers. PEG can also facilitate a rapid response in the assay. In various other embodiments the reaction layer can also contain mediators, surfactants, stabilizers, and polymers, and any other reagents that are useful for conducting the assay.

Measuring Device

After loading with sample, the biosensor test strip is inserted into a measuring device and is thereby electrically connected to the device, which will apply voltage to the biosensor test strip and contains software to perform the determination of the presence or amount of the analyte. Various devices can be used in the present invention to apply voltage to the biosensor test strip and apply the methods described herein. In some embodiments metering devices supply a voltage to the biosensor through one or more electrodes, and detect or measure a current at one or more additional electrodes. In one embodiment the metering device records the data collected from the biosensor and converts the data into a concentration of the analyte in the sample. This concentration can then be displayed to the user.

For example, in one embodiment glucose meters used with glucose biosensor test strips measure the concentration of glucose in a sample of blood provided by a user. Various types of metering devices are commercially available and are configured for testing the concentration of glucose in a sample, or that of another analyte. Specialty meters, such as cholesterol meters, alcohol meters, or meters for detecting the presence or concentration of choline or acetylcholine are also available.

Sample

In one embodiment the sample is a biological fluid. Examples of biological fluids include blood or a blood product, urine, and a solid or semisolid mixed with a diluent, such as water or buffer. Using the present invention, any analyte can be detected in a fluid sample for which there can be designed an electrochemical assay. Some examples of analytes that can be detected using the present invention are glucose, lactate, cholesterol, urea, bicarbonate, 3-hydroxybutyric acid (3-HBA), amino acids (e.g., L-glutamate, aspartate, L-lysine), ammonium, sodium, calcium, trace metals, and any other analyte for which there can be designed an electrochemical assay. The reagents in the reaction layer will of course be changed to those appropriate for testing for the analyte of interest. When 3-HBA is the analyte, mediators such as K₃Fe(CN)₆, ferrocene, hexacyanpferrate, and enzymes such as 3-HBA dehydrogenase and diaphorase, and the cofactor NAD can be included in the reagent layer.

Any sample fluid (or fluidized sample) can be analyzed using the devices. Examples of sample fluids that can be tested include whole blood, blood serum, blood plasma, urine, and saliva. Clinical samples, biological samples, and environmental samples can also be tested, whether they are supplied as fluids or are liquefied before analysis. The sample fluid can also be a buffer, or a solution or suspension containing a solid or gaseous biological material. The present biosensors and methods can be used to qualitatively or quantitatively detect any analyte or enzyme.

Method of Use

The present invention provides methods of detecting application of a sample to a biosensor. The methods are useful in the use of a meter for detecting the presence or amount of an analyte in a sample, since inadequate filling of the capillary channel of biosensor test strips can cause meter readings to be inaccurate.

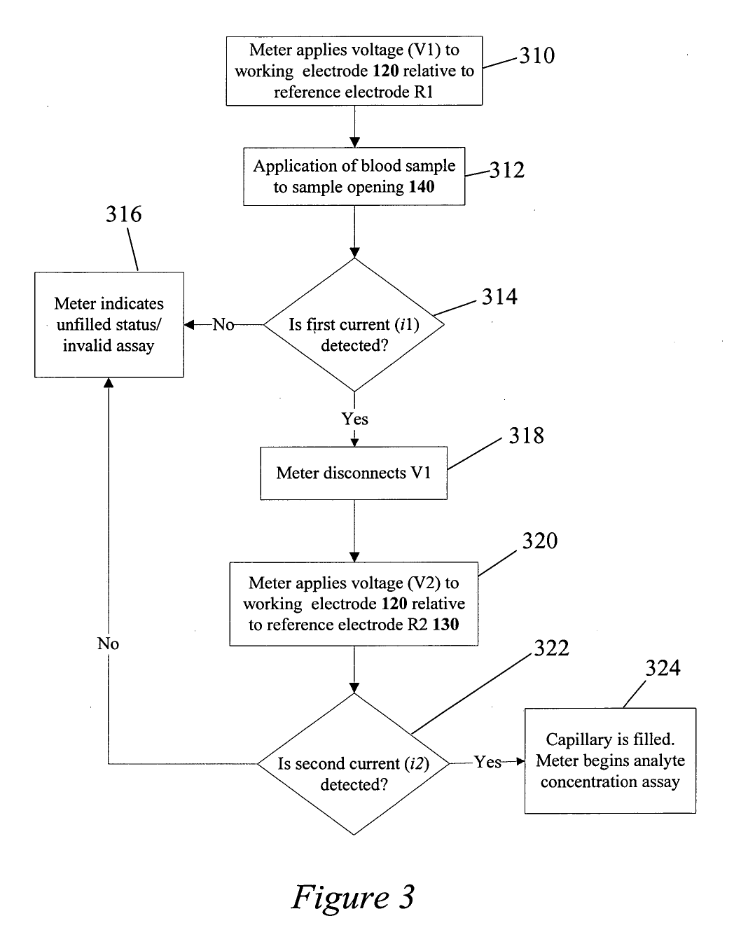

One embodiment of the method is illustrated in FIG. 3. In this embodiment a first voltage (V1) is applied to the working electrode relative to the first reference electrode R1 (step 310). The first voltage V1 can be any appropriate voltage. In one embodiment 400 mV is applied to the working electrode relative to R1. In other embodiments a different voltage is applied to the working electrode, such as from 200 mV to 600 mV, or at least 200 mV or at least 300 mV or at least 400 mV. In this embodiment the voltage V1 is applied before the sample is loaded into the capillary channel, but in other embodiments the voltage V1 can also be applied after application of the sample to the capillary channel.

In this embodiment, after application of the voltage V1 a sample (e.g., blood) is applied to the sample opening (step 312). After the sample is loaded into the capillary, a first current (i1) is detected (step 314) if the sample has covered both the working electrode (W) and R1. The current i1 can be of any appropriate amount. In various embodiments i1 is about 30 nAmps, or from 30 nAmps to 1000 nAmps, or at least 10 nAmps, or at least 15 nAmps, or at least 20 nAmps or at least 25 nAmps, or at least 30 nAmps, but any amount of amperage that can be resolved by the particular equipment involved can be used. If i1 is not detected, this indicates that sample has not covered both the first reference and working electrodes. The firmware or software can be programmed to allow a specific amount of time within which to detect the sample application. If no sample is detected after a set time period, the meter indicates a failure to load the sample (step 316). If i1 is detected, V1 is turned off (step 318) and the second voltage (V2) is applied to the working electrode relative to the second reference electrode R2 (step 320).

The second voltage V2 is applied in an amount of 400 mV, but in other embodiments V2 can be any number of mV that functions with the specific equipment involved, for example, from 200 mV to 600 mV. In various embodiments i2 is about 30 nAmps, or from 30 nAmps to 1000 nAmps, or at least 10 nAmps, or at least 15 nAmps, or at least 20 nAmps or at least 25 nAmps, or at least 30 nAmps, but any amount of amperage that can be resolved by the particular equipment involved can be used. If i2 is not detected, the meter signals an invalid assay (step 316). However, if i2 is detected, this indicates that sample is fully loaded in the capillary channel and has covered all three electrodes (step 324). In various embodiments i2 is detected from within a few milliseconds (e.g., 20 milliseconds, 30 milliseconds, 40 milliseconds, 50 milliseconds, 75 milliseconds, or 100 milliseconds) to a few seconds (e.g., 2 seconds, or 3 seconds, or 4 seconds, or 5 seconds) after detection of il. If i2 is detected, the biosensor is ready to have a valid assay performed. Voltage is then applied to the working electrode relative to the R2 reference electrode in one embodiment, or relative to both the R1 and R2 electrodes in another embodiment, and the current detected. The current is correlated by firmware or software to a specific concentration of analyte present in the sample, and the result displayed by the meter.

In one embodiment of the present method, the first reference electrode, working electrode, and second reference electrode lie perpendicular to the axis of the capillary channel. In a further embodiment, the first reference electrode, working electrode, and second reference electrode are arranged sequentially within the capillary channel, such that the first reference electrode is closest to the opening of the capillary channel and the second reference electrode is farthest from the opening of the capillary channel. The biosensor can have a vent through which air from the capillary channel can pass to the exterior of the biosensor.

The biosensor also has at least three leads. The leads electrically connect the working electrode, first reference electrode, and second reference electrode to contacts, which in turn electrically connect the biosensor to the metering device. In one embodiment there are three leads, each independently connecting an electrode to a contact. The electrodes can be formed of an electrically insulating dielectric ink. The electrically insulating dielectric ink can contain silver, platinum, palladium, gold, carbon, and any combination thereof. The biosensor can also have, within the capillary channel, reagents for detecting the analyte. The reagents can include an enzyme and a mediator. In certain embodiments, the enzyme is deposited only on the working electrode and the mediator is deposited on all three electrodes.

### EXAMPLE 1

### Construction of a Biosensor

This example illustrates the manufacture of a biosensor used in the invention. A polyester substrate was selected to form the base layer (Tekra Corporation) and was cut into 15×15 inch segments. A carbon ink (BQ242 from Dupont) was screen printed onto the 15×15 inch substrate pieces using a screen printer (Dom SPE Inc., Garden Grove, Calif.). The ink was dried at 130° C. for 5 min using a thermal conveyor belt system present on the screen printer. A silver ink (E1660 from Ercon Inc., Wareham, Mass.) is screen printed to form the electrical connecting leads of the biosensor. The ink is cured at 130° C. for 5 min using the thermal conveyor belt system present on the screen printer. The UV dielectric ink (TGH1019-GN) was screen printed and cured by the UV system of the screen printer.

The spacer used was a double-sided pressure sensitive medical grade adhesive. The spacer material was laser cut into individual rows of 15 inches by 1 inch in dimension and having individual cut channels of 2 mm by 10 mm in dimension representing individual biosensor strips. The screen printed biosensor substrate was then laminated with the individual row of hydrophilic spacer material in an aligned manner.

The glucose reagent was used in the first and second layer of reagents. The glucose reagent was formulated and dispensed as a single drop (0.90 uL) on the individual biosensor strips covering the first reference electrode, working electrode, and the second reference electrode using a dispenser system (Champion Dispensor, IVEK Corp., No. Springfield, Vt.). The dispensed reagent was cured at 65 C for 5 minutes on a thermal conveyor belt system. The second layer of glucose reagent was then dispensed in the same manner on the 15×15 substrate and heat cured at 65 C for 5 minutes.

The hydrophilic top cover was laser cut into individual rows of 15 inches by 1 inch wide having the vent hole for each individual biosensor strips. And having a vest hole for each of the individual biosensor test strips. The individual rows of the hydrophilic top cover were then laminated to double sided pressure sensitive spacers, respectively, in an aligned manner to complete the biosensor assembly.

The 15×15 biosensor substrate assembled is then cut into individual strips using a rotary cutter. The individual strips were packaged into a dessicant vial for storage and future use.

### EXAMPLE 2

### Blood Glucose Assay

Venous blood samples of three different glucose concentrations (100, 250, and 450 mg/dL) were run on the glucose biosensor strips and the data was recorded using a glucose meter (ON CALL™, ACON Laboratories, Inc., San Diego, Calif.). The same samples were also assayed on a reference instrument glucose meter (YSI Inc., Yellow Springs, Ohio). The glucose data from the ON CALL™ glucose meter was plotted on the Y-axis while the data from the reference instrument was plotted on the X-axis, and a linear regression analysis was performed.

The glucose system using the method of the present invention as compared to the reference instrument provided a linear relationship, with a regression coefficient of r2=0.9913, Slope=1.0025, and Intercept=0.1708 mg/dL, with N=252 samples.

The invention illustratively described herein may be practiced in the absence of any element or elements, limitation or limitations that are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by various embodiments and optional features, modification and variation of the concepts herein disclosed may be resorted to by those skilled in the art, and that such modifications and variations are considered to be within the scope of this invention as defined by the appended claims.

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other documents.

1. A method of detecting application of liquid sample to a biosensor comprising
contacting the liquid sample with a biosensor comprising
an opening to a capillary channel containing a first reference electrode, a working electrode, and a second reference electrode comprised on a substrate,
electrically connecting the biosensor to a device for applying voltage to the biosensor;
applying a first voltage (V1) to the working electrode relative to the first reference electrode and detecting a first current (i1);
applying a second voltage (V2) to the working electrode relative to the second reference electrode and detecting a second current (i2), wherein the presence of i2 indicates sample has been applied to the biosensor;
thereby detecting application of the liquid sample to the biosensor.

2. The method of claim 1 wherein the first reference electrode, working electrode, and second reference electrode lie perpendicular to the axis of the capillary channel.

3. The method of claim 2 wherein the first reference electrode, working electrode, and second reference electrode are comprised on sequential axes lying perpendicular to the axis of the capillary channel.

4. The method of claim 3 wherein the sequential axes are linear axes.

5. The method of claim 3 wherein the first reference electrode is closest to the sample opening of the capillary channel and the second reference electrode is farthest from the sample opening of the capillary channel.

6. The method of claim 1 wherein the biosensor further comprises a vent for passage of air from the capillary channel to the exterior of the biosensor.

7. The method of claim 1 the biosensor further comprises at least three leads for independently connecting the first reference electrode, working electrode, and second reference electrode to at least three independent contacts of a metering device.

8. The method of claim 1 wherein the electrodes are comprised of an electrically conducting ink.

9. The method of claim 8 wherein the electrically conducting ink is comprised of a material selected from the group consisting of: silver, platinum, palladium, gold, carbon, and any combination thereof.

10. The method of claim 1 wherein the biosensor further comprises reagents for detecting an analyte comprised within the capillary channel.

11. The method of claim 10 wherein the reagents comprise an enzyme and a mediator.

12. The method of claim 11 wherein the enzyme is deposited only on the working electrode and the mediator is deposited on all three electrodes.

13. The method of claim 1 wherein if i1 is detected, V1 is discontinued before applying the second voltage (V2).

14. The method of claim 13 wherein if i2 is detected, the device determines the concentration or amount of an analyte in the liquid sample.

15. The method of claim 1 wherein if i1 is not detected, an error is reported.

16. The method of claim 1 wherein if i1 is detected but i2 is not detected, then an error is reported.

17. The method of claim 10 wherein the biosensor comprises reagents for detecting an analyte selected from the group consisting of: glucose, cholesterol, and alcohol.

18. The method of claim 1 wherein the sample is a biological sample.

19. The method of claim 1 wherein the sample is blood or a blood product.

20. The method of claim 1 wherein the biosensor comprises a polyester substrate.

21. The method of claim 20 wherein the capillary is formed from a spacer and hydrophilic top cover comprised on the substrate.
